(19) United States
(12) Patent Application Publication
(10) Pub. No.: US 2025/0191017 A1
(43) Pub. Date: Jun. 12, 2025

(54) SALES COMPENSATION PAYOUT FORECASTING USING REINFORCEMENT LEARNING

(71) Applicant: Dell Products L.P., Round Rock, TX (US)

(72) Inventors: Srishti Gupta, Delhi (IN); Sailendu Kumar Patra, Bangalore (IN); Saurabh Jha, Austin, TX (US)

(21) Appl. No.: 18/537,155

(22) Filed: Dec. 12, 2023

(51) Int. Cl. G06Q 30/0214

(52) U.S. Cl. CPC G06Q 30/0214

(57) ABSTRACT

A method for forecasting sales compensation payouts. The method includes: constructing a current seller group quota histogram using current seller group quota data; identifying a best-fit distribution for the current seller group quota histogram; and computing a sales compensation payout forecast based on the best-fit distribution and an accelerator payout curve.

### BACKGROUND

Sales compensation is a key incentive for any sales team as it motivates any salesperson (or any group thereof) in pushing further sales, which in turn compels business growth. For any business, sales play a vital role in improving the business and extending product and/or service reach. In having a large global sales force, the business needs to be vigilant on the sales compensation paid out to their sales team.

### SUMMARY

In general, in one aspect, embodiments described herein relate to a method for forecasting sales compensation payouts. The method includes: constructing a current seller group quota histogram using current seller group quota data; identifying a best-fit distribution for the current seller group quota histogram; and computing a sales compensation payout forecast based on the best-fit distribution and an accelerator payout curve.

In general, in one aspect, embodiments described herein relate to a non-transitory computer readable medium (CRM). The non-transitory CRM includes computer readable program code, which when executed by a computer processor, enables the computer processor to perform a method for forecasting sales compensation payouts. The method includes: constructing a current seller group quota histogram using current seller group quota data; identifying a best-fit distribution for the current seller group quota histogram; and computing a sales compensation payout forecast based on the best-fit distribution and an accelerator payout curve.

In general, in one aspect, embodiments described herein relate to a system. The system includes: a sales compensation payout forecaster. The sales compensation payout forecaster includes: a storage; and a computer processor operatively connected to the storage, and configured to perform a method for forecasting sales compensation payouts. The method includes: constructing a current seller group quota histogram using current seller group quota data retrieved from the storage; identifying a best-fit distribution for the current seller group quota histogram; and computing a sales compensation payout forecast based on the best-fit distribution and an accelerator payout curve.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1A shows a system in accordance with one or more embodiments described herein.

FIG. 1B shows a sales compensation payout forecaster in accordance with one or more embodiments described herein.

FIGS. 2A and 2B show a flowchart describing a method for processing forecast requests in accordance with one or more embodiments described herein.

FIG. 3 shows a computing system in accordance with one or more embodiments described herein.

FIG. 4 shows an example seller group quota histogram in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to sales compensation payout forecasting using reinforcement learning. For context, sales compensation payout based on seller quota attainment refers to a compensation structure where a seller's earnings or bonuses are determined by their ability to meet or exceed specific sales targets or quotas set by their employer. In said compensation structure, sellers are typically assigned individual sales targets or quotas that they are expected to achieve within a specified time period, such as a month, a quarter, or a year. The specific targets can vary depending on the organization and industry. For example, a salesperson may have a quota based on the total revenue generated from their sales, the number of units sold, or the number of new customers acquired. When a seller meets or surpasses their quota, they become eligible for additional compensation, often in the form of bonuses or commission on sales. Further, the sales compensation payout may be structured as a percentage of the sales revenue, a flat bonus amount, or a combination of both. On the other hand, if a seller fails to meet their quota, their sales compensation payout may be reduced, or they may receive no additional compensation beyond their base salary. Some businesses or organizations may implement a tiered compensation structure, where sellers receive different levels of sales compensation payouts based on their performance relative to their quota.

Sales compensation is a key incentive for any sales team as it motivates any salesperson (or any group thereof) in pushing further sales, which in turn compels business growth. For any business, sales play a vital role in improving the business and extending product and/or service reach. In having a large global sales force, the business needs to be vigilant on the sales compensation paid out to their sales team. The specific details of a compensation structure, including the quota levels and corresponding payouts, are typically outlined in a sales compensation plan or agreement provided by the employer. It is important for sellers to understand these details to know what is expected of them and how their compensation is tied to their performance. Due to the complexity of sales compensation calculations involving multiple parameters and metrics, coupled with a large sales team, it is not uncommon for errors to occur. These errors typically stem from manual mistakes made at different stages of the calculation process. Given that these calculations are performed daily across different regions, identifying and rectifying errors in any sales compensation payout becomes a challenging task as it often necessitates an exhaustive analysis of millions of records to pinpoint any inaccuracies, thereby consuming considerable time and resources.

Embodiments described herein propose a solution addressing the above-mentioned issue(s). Particularly, said solution entails sales compensation payout forecasting leveraging the latest business and seller performance actuals (e.g., business attainment, forecasted end of business fiscal period attainment, quota attainment, business to quota gap, seller distributions, windfalls etc.). The solution further leverages reinforcement learning via a stochastic multi-armed bandit algorithm to identify the best distribution that overlays seller quota attainment data for a specified business fiscal period. Additionally, the solution treats and rectifies said best distribution when impacted by any anomalous seller(s) that may skew the data represented thereof.

Through various test scenarios, the solution has consistently achieved over 95% accuracy in forecasting the sales compensation payout across various seller groups in an organization. Moreover, the solution purportedly saves an organization thousands of hours a year in time and labor resources required in the manual forecasting of sales compensation payouts.

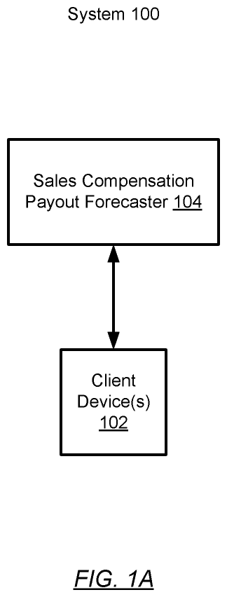

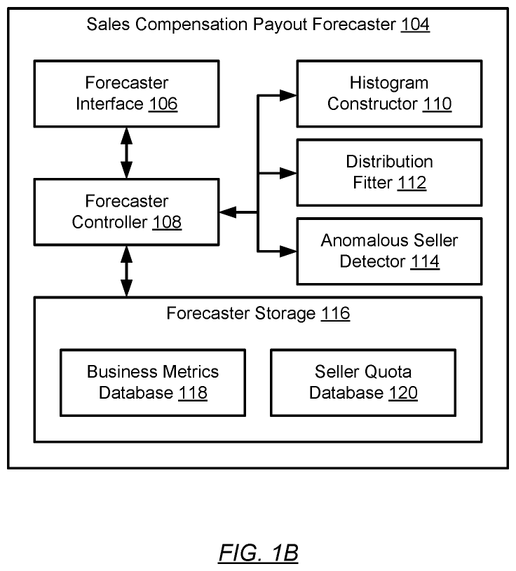

FIG. 1A shows a system in accordance with one or more embodiments described herein. The system (100) may include one or more client devices (102) and a sales compensation payout forecaster (104). Each of these system (100) components is described below.

In one or many embodiment(s) described herein, any client device (102) may represent a physical appliance or computing device operated by one or many business decision maker(s) of a business. A business may refer to an organization or an enterprise at least engaged in for-profit commercial, industrial, or professional activities, whereas a business decision maker may refer to an individual whom may have the authority to make strategic decisions concerning operations involved in the business. One of said operations may pertain to the sale of products and/or services offered by the business. With respect to these sales operations, the business decision maker(s) may, for example, be responsible for: establishing sales targets not only for the overall business, but also for individual salespersons as well, for any given period of time; drafting sales compensation or incentive structures; capturing and reviewing sales performance metrics or indicators; and projecting or forecasting sales revenues, sales compensation payouts, etc.

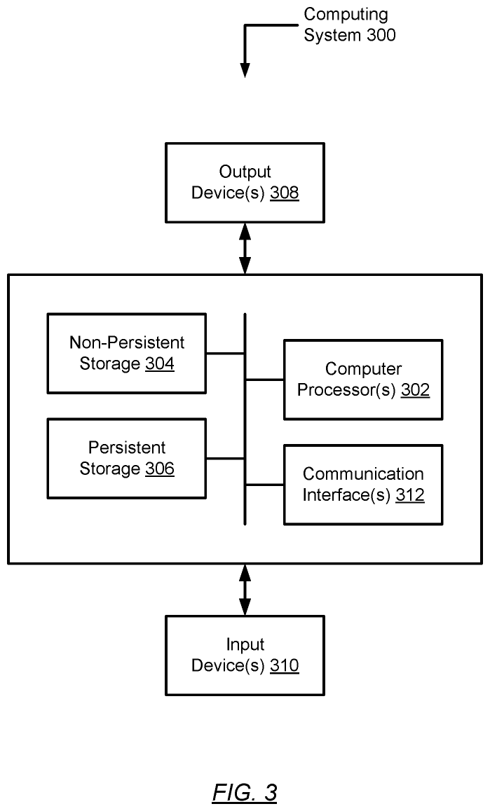

Examples of any client device (102) may include, but are not limited to, a desktop computer, a laptop computer, a network server, a smartphone, a tablet computer, or any other computing system similar to the computing system illustrated and described with respect to FIG. 3, below.

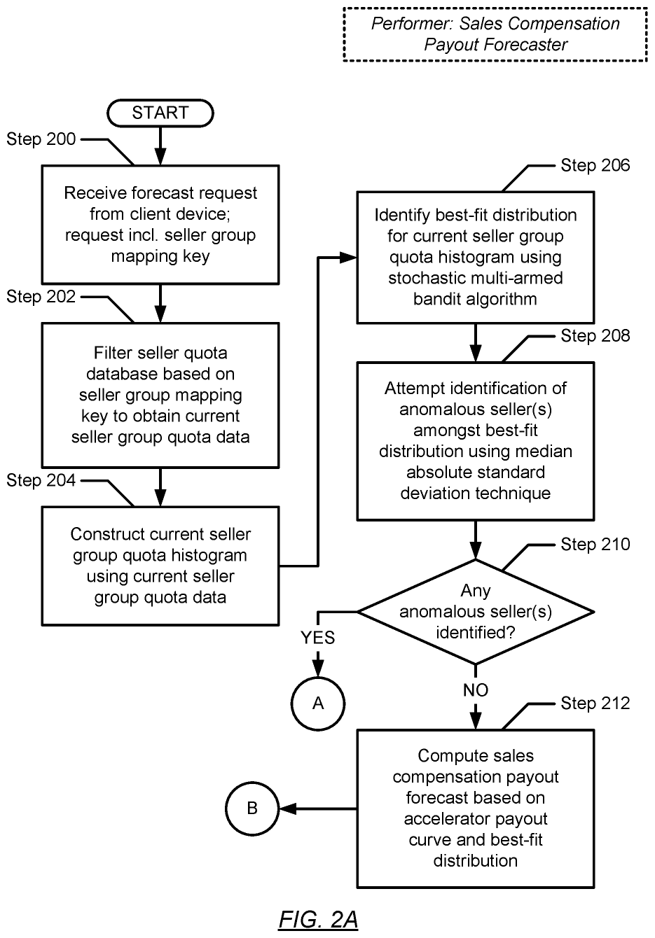

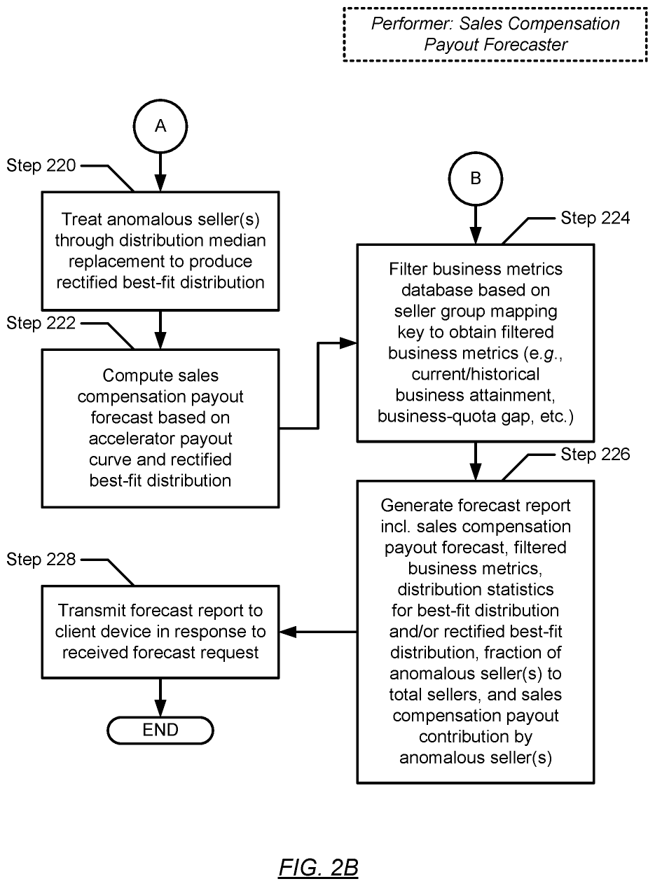

In one or many embodiment(s) described herein, and at least in part, any client device (102) may include functionality to: generate and transmit any number of forecast requests to the sales compensation payout forecaster (104); and receive, in response to any said transmitted forecast request, a corresponding forecast report from and generated by the sales compensation payout forecaster (104). Forecast requests and forecast reports are defined below with respect to FIGS. 2A and 2B. Further, one of ordinary skill will appreciate that any client device (102) may perform other functionalities without departing from the scope of the embodiments described herein.

In one or many embodiment(s) described herein, the sales compensation payout forecaster (104) may represent any enterprise information technology (IT) infrastructure at least configured to project sales compensation payouts for any given business fiscal period (e.g., half-year, quarter, etc.). A projected sales compensation payout (also referred herein as a sales compensation payout forecast), in turn, may refer to an estimate of total funds, relative to and expressed as a percentage of a previously established budget, for covering the commissions earned by a group of salespersons (or sellers) for a given business fiscal period.

In one or many embodiment(s) described herein, the sales compensation payout forecaster (104) may be implemented through on-premises infrastructure, cloud computing infrastructure, or any hybrid infrastructure thereof. As such, the sales compensation payout forecaster (104) may be implemented using one or more network servers (not shown), where each network server may represent a physical network server or a virtual network server. Additionally, or alternatively, the sales compensation payout forecaster (104) may be implemented using one or more computing systems similar to the computing system illustrated and described with respect to FIG. 3, below.

In one or many embodiment(s) described herein, and at least in part, the sales compensation payout forecaster (104) may include functionality to: forecast sales compensation payouts through the processing of forecast requests submitted by any client device (102)—the method for doing so being illustrated and described below with respect to FIGS. 2A and 2B. One of ordinary skill, however, will appreciate that the sales compensation payout forecaster (104) may perform other functionalities without departing from the scope of the embodiments described herein. Moreover, the sales compensation payout forecaster (104) is illustrated and described in further detail below with respect to FIG. 1B.

In one or many embodiment(s) described herein, the above-mentioned system (100) components may communicate with one another through a network (not shown) (e.g., a local area network (LAN), a wide area network (WAN) such as the Internet, a mobile network, any other network type, or any combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components. Moreover, in communicating with one another, the above-mentioned system (100) components may employ any combination of wired and/or wireless communication protocols.

While FIG. 1A shows a configuration of components and/or subcomponents, other system (100) configurations may be used without departing from the scope of the embodiments described herein.

FIG. 1B shows a sales compensation payout forecaster in accordance with one or more embodiments described herein. The sales compensation payout forecaster (104) may include a forecaster interface (106), a forecaster controller (108), a histogram constructor (110), a distribution fitter (112), an anomalous seller detector (114), and forecaster storage (116). Each of these sales compensation payout forecaster (104) components is described below.

In one or many embodiment(s) described herein, the forecaster interface (106) may refer to networking hardware (e.g., a network card or adapter), a computer program implementing a logical interface (e.g., an application programming interface (API)) and executing on the underlying hardware of the sales compensation payout forecaster (104), an interactivity protocol, or any combination thereof, at least configured to enable or facilitate communications (or information exchange) between the sales compensation payout forecaster (104) and other entities (e.g., any client device(s) (see e.g., FIG. 1A)).

In one or many embodiment(s) described herein, and at least in part, the forecaster interface (106) may include functionality to: receive any number of forecast requests from any client device, each specifying a seller group mapping key; provide said received forecast request(s) to the forecaster controller (108) for processing; obtain any number forecast reports (see e.g., FIGS. 2A and 2B) from the forecast controller (108), each specifying a sales compensation payout forecast and other information; and transmit the obtained forecast report(s) to the client device in response to the forecast request(s) received therefrom. One of ordinary skill, however, will appreciate that the forecaster interface (106) may perform functionalities without departing from the scope of the embodiments described herein.

In one or many embodiment(s) described herein, the forecaster controller (108) may refer to instruction-processing hardware (e.g., any number of integrated circuits for processing computer readable instructions), a computer program executing on the underlying hardware of the sales compensation payout forecaster (104), or any combination thereof, at least configured to orchestrate or manage sales compensation payout forecaster (104) operations.

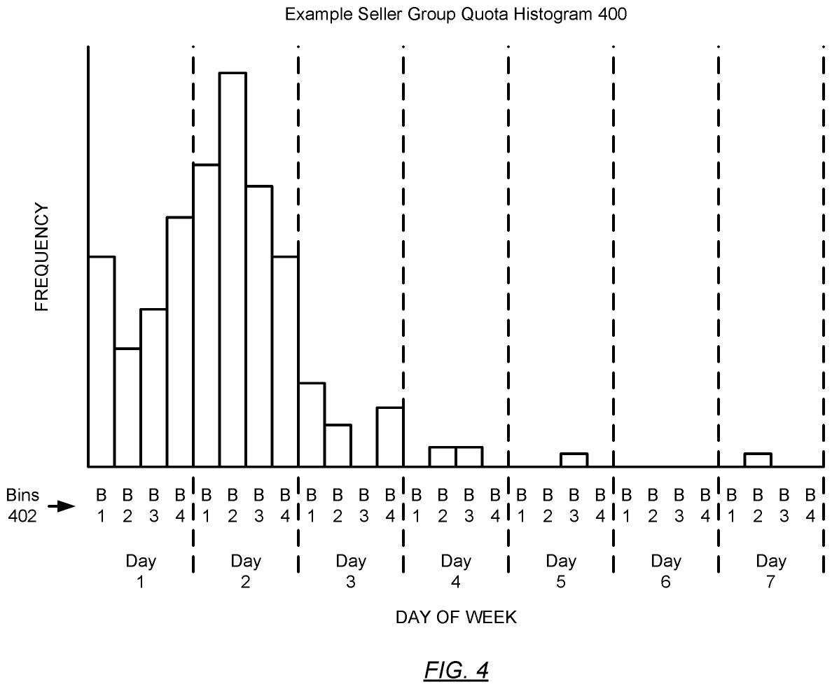

In one or many embodiment(s) described herein, and at least in part, the forecaster controller (108) may include functionality to: obtain any number of forecast requests from any client device via the forecaster interface (106), where each forecast request specifies a seller group mapping key; obtain current seller group quota data (i.e., maintained on the forecaster storage (116)) based on and corresponding to the seller group mapping key; invoke the histogram constructor (110) to construct any number of current seller group quota histograms (see e.g., FIG. 4) reflecting the obtained seller group quota data; invoke the distribution fitter (112) to identify any number of best-fit distributions representative of the constructed current seller group quota histogram(s); invoke the anomalous seller detector (114) to attempt identification of any number of anomalous sellers (or outliers) amongst the identified best-fit distribution(s); should any anomalous seller(s) be identified—(i) treat the identified anomalous seller(s) to produce any number of rectified best-fit distributions, and (ii) compute any number of sales compensation payout forecasts based on any number of accelerator payout curves and the produced rectified best-fit distribution(s); otherwise, should any anomalous seller(s) not be identified—compute any number of sales compensation payout forecasts based on the accelerator payout curve(s) and the identified best-fit distribution(s); obtain filtered business metrics (i.e., maintained on the forecaster storage (116)) based on and corresponding to the seller group mapping key; generate any number of forecast reports, each specifying at least the computed sales compensation payout forecast and the obtained filtered business metrics; and provide the generated forecast report(s) to the forecaster interface (106), where each forecast report is to be transmitted towards an appropriate client device for review by any operator(s) of the client device. One of ordinary skill, however, will appreciate that the forecaster controller (108) may perform other functionalities without departing from the scope of the embodiments described herein.

In one or many embodiment(s) described herein, the histogram constructor (110) may refer to instruction-processing hardware (e.g., any number of integrated circuits for processing computer readable instructions), a computer program executing on the underlying hardware of the sales compensation payout forecaster (104), or any combination thereof, at least configured to construct seller group quota histograms (see e.g., FIG. 4).

In one or many embodiment(s) described herein, and at least in part, the histogram constructor (110) may include functionality to: obtain instructions from the forecaster controller (108)—the instructions specifying current seller group quota data; based on a predefined cardinality of bins and a predefined bin width, construct a current seller group quota histogram using (or reflective of) the specified current seller group quota data; and provide the constructed current seller group quota histogram to the forecaster controller (108) in response to the obtained instructions. One of ordinary skill, however, will appreciate that the histogram constructor (110) may perform other functionalities without departing from the scope of the embodiments described herein.

In one or many embodiment(s) described herein, the distribution fitter (112) may refer to instruction-processing hardware (e.g., any number of integrated circuits for processing computer readable instructions), a computer program executing on the underlying hardware of the sales compensation payout forecaster (104), or any combination thereof, at least configured to identify best-fit distributions representative of seller group quota histograms.

In one or many embodiment(s) described herein, and at least in part, the distribution fitter (112) may include functionality to: obtain instructions from the forecast controller (108)—the instructions specifying a constructed current seller group quota histogram (see e.g., FIG. 4); using a reinforcement learning based stochastic multi-armed bandit algorithm, identify a best-fit distribution (e.g., burr, log-normal, normal, gamma, etc.) representative of the specified current seller group quota histogram; and provide the identified best-fit distribution to the forecast controller (108) in response to the obtained instructions. One of ordinary skill, however, will appreciate that the distribution fitter (112) may perform other functionalities without departing from the scope of the embodiments described herein.

In one or many embodiment(s) described herein, the anomalous seller detector (114) may refer to instruction-processing hardware (e.g., any number of integrated circuits for processing computer readable instructions), a computer program executing on the underlying hardware of the sales compensation payout forecaster (104), or any combination thereof, at least configured to attempt identification of any anomalous seller(s) amongst best-fit distributions.

In one or many embodiment(s) described herein, and at least in part, the anomalous seller detector (114) may include functionality to: obtain instructions from the forecast controller (108)—the instructions specifying an identified best-fit distribution (e.g., burr, log-normal, normal, gamma, etc.) representative of a constructed current seller group quota histogram (see e.g., FIG. 4); using a median absolute standard deviation technique, identify (or not identify) one or more outliers (i.e., anomalous sellers) amongst the specified best-fit distribution; and provide the identified anomalous seller(s) (if any) to the forecast controller (108) in response to the obtained instructions. One of ordinary skill, however, will appreciate that the anomalous seller detector (114) may perform other functionalities without departing from the scope of the embodiments described herein.

In one or many embodiment(s) described herein, the forecaster storage (116) may refer to a collection of one or more physical storage devices (not shown) on which various forms of digital information—e.g., a business metrics database (118) (described below) and a seller quota database (120) (described below)—may be maintained. Each physical storage device may encompass non-transitory computer readable storage media on which said digital information may be stored in whole or in part, and temporarily or permanently. Further, the forecaster storage (116) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, the business metrics database (118) may refer to a dedicated data repository configured to maintain any number of business metrics database entries (not shown). Each business metrics database entry, in turn, may store any number of business performance metrics captured for and respective to a business fiscal period (e.g., half-year, quarter, etc.). Examples of said business performance metrics, associated with a given business fiscal period, may include, but are not limited to: business attainment, or the measure of the business's performance (e.g., actual revenue) as a percentage of the business's operating plan (e.g., anticipated revenue) for the given business fiscal period; quota attainment, or the measure of a seller's or seller group's performance (e.g., actual sales) as a percentage of the seller's or seller group's quota (e.g., target sales) for the given business fiscal period; business-to-quota attainment gap, or the difference in basis points (bps) between the business's performance and the seller's (or seller group's) performance for the given business fiscal period; and business intra-period growth, or the measure of the business's performance growth (in bps) between the given business fiscal period and the previous business fiscal period.

In one or many embodiment(s) described herein, the seller quota database (120) may refer to a dedicated data repository configured to maintain any number of seller quota database entries (not shown). Each seller quota database entry, in turn, may store any number of seller parameters pertinent to an individual seller. Examples of said seller parameters, associated with a given seller, may include, but are not limited to: a seller identifier referring to a character string uniquely identifying the given seller; a seller location referring to a geographical setting wherein the given seller operates; one or more seller lines each referring to a product or service line that the given seller is responsible for selling; a sales quota or target assigned to the given seller for a specified time period (e.g., weekly, monthly, business fiscal period, etc.); a payout structure or curve defining the incentive payout rewarded to the given seller based on tiered sales performance levels; and any number of daily quota attainment values each referring to the actual sales amount achieved by the given seller per day as a percentage of their assigned sales quota/target (for a specified time period).

While FIG. 1B shows a configuration of components and/or subcomponents, other sales compensation payout forecaster (104) configurations may be used without departing from the scope of the embodiments described herein.

FIGS. 2A and 2B show a flowchart describing a method for processing forecast requests in accordance with one or more embodiments described herein. The various steps outlined below may be performed by the sales compensation payout forecaster (see e.g., FIGS. 1A and 1B). Further, while the various steps in the flowchart are presented and described sequentially, one of ordinary skill will appreciate that some or all steps may be executed in different orders, may be combined or omitted, and some or all steps may be executed in parallel.

Turning to FIG. 2A, in Step 200, a forecast request is received from a client device (see e.g., FIG. 1A). In one or many embodiment(s) described herein, the forecast request may pertain to ascertaining a sales compensation payout forecast—i.e., an estimate of total funds, relative to and expressed as a percentage of a previously established budget, for covering the commissions earned by a group of salespersons (or sellers) for a given business fiscal period. Further, the forecast request may include or specify a seller group mapping key. The seller group mapping key may refer to a search string (e.g., a combination of keywords, Boolean operators, etc.) that specifies one or more parameters (or filters) through which sought database entries (from the seller quota database and/or the business metrics database (see e.g., FIG. 1B)) may be identified. Examples of said filter(s) may include, but is/are not limited to: a sought time period or span (e.g., a certain week of a certain year); a seller location referring to a geographical setting wherein a seller or a seller group operates; and one or more seller lines each referring to a product or service line that a seller is responsible for selling.

In Step 202, a seller quota database (see e.g., FIG. 1B) is filtered based on the seller group mapping key (included in the forecast request received in Step 200). In one or many embodiment(s) described herein, from said filtering, at least a subset of the seller quota database entries may be identified. Further, from each said identified seller quota database entry, at least a subset of the daily quota attainment values (described above) (e.g., recorded for a sought timer period or span) therein may be aggregated for the group of sellers corresponding to the identified subset of the seller quota database entries. Said aggregated daily quota attainment values, across the identified seller group, may also be referred to herein as current seller group quota data.

In Step 204, using the current seller group quota data (obtained in Step 202), a current seller group quota histogram is constructed. In one or many embodiment(s) described herein, the current seller group quota histogram may refer to a graphical representation (e.g., a bar graph) of the total daily quota attainment distribution reflected in the current seller group quota data. An example seller group quota histogram is illustrated and described in further detail with respect to FIG. 4, below.

In Step 206, a best-fit distribution is identified for the current seller group quota histogram (constructed in Step 204). In one or many embodiment(s) described herein, the best-fit distribution may refer to a probability distribution (e.g., discrete or continuous) that best represents or fits the current seller group quota histogram. Identification of the best-fit distribution, further, may result from the use of reinforcement learning or, more specifically, through the utilization of a stochastic multi-armed bandit algorithm. Through said algorithm, multiple variations (e.g., defined via differing values of their respective parameters) of different distributions (e.g., burr, normal, log-normal, beta, gamma, etc.) may be created and laid over the current seller group quota histogram to identify the best-fit distribution based, at least in part, on the overlaid distribution that the greatest return and the lowest total regret. As the stochastic multi-armed bandit algorithm is a known artificial intelligence technique, further details descriptive thereof will not be discussed in this disclosure.

In Step 208, identification of one or more anomalous sellers is attempted. That is, in one or many embodiment(s) described herein, any anomalous seller may represent an outlier in the best-fit distribution (identified in Step 206). Further, any said anomalous seller(s) may be identified through an existing median absolute standard deviation technique, where said anomalous seller(s) may be associated with modified z-scores (i.e., =0.6745×[daily quota attainment value−median daily quota attainment value]/median absolute deviation of current seller group quota data) of at least plus or minus three (3) points.

In Step 210, a determination is made as to whether any anomalous seller(s) (attempted to be identified in Step 208) is/are identified. In one or many embodiment(s) described herein, if it is determined that zero outliers (or anomalous sellers) have been identified, then the method proceeds to Step 212. On the other hand, in one or many other embodiment(s) described herein, if it is alternatively determined that at least one outlier (or anomalous seller) has been identified, then the method alternatively proceeds to Step 220 (see e.g., FIG. 2B).

In Step 212, following the determination (made in Step 210) that zero anomalous sellers have been identified based on the identification attempt (made in Step 208), a sales compensation payout forecast is computed. In one or many embodiment(s) described herein, the sales compensation payout forecast (defined above—see e.g., Step 200) may be calculated through the dot product, or the element-wise multiplication, of two vectors—the best-fit distribution (identified in Step 206) and an accelerator payout curve reflecting the compensation payout rate per seller in the seller group.

Following Step 212, the method proceeds to Step 224 (see e.g., FIG. 2B).

Turning to FIG. 2B, in Step 220, following the alternate determination (made in Step 210) that at least one anomalous seller has been identified based on the identification attempt (made in Step 208), a treatment for said at least one anomalous seller is performed. In one or many embodiment(s) described herein, the treatment, as applied to any given anomalous seller, may entail replacing an existing daily quota attainment value for the given anomalous seller with a distribution median of (or a median daily quota attainment value reflected in) the best-fit distribution (identified in Step 206). Following incorporation of the treated anomalous seller(s) therein, the best-fit distribution hereinafter is referred to as a rectified best-fit distribution.

In Step 222, a sales compensation payout forecast is computed. In one or many embodiment(s) described herein, the sales compensation payout forecast (defined above—see e.g., Step 200) may be calculated through the dot product, or the element-wise multiplication, of two vectors—the rectified best-fit distribution (produced in Step 220) and an accelerator payout curve reflecting the compensation payout rate per seller in the seller group.

In Step 224, a business metrics database (see e.g., FIG. 1B) is filtered based on the seller group mapping key (included in the forecast request received in Step 200). In one or many embodiment(s) described herein, from said filtering, two business metrics database entries—i.e., one respective to the current business fiscal period and the other respective to the previous business fiscal period—may be identified. Further, from each said identified business metrics database entry, at least a subset of the business performance metrics recorded therein may be retrieved. Examples of the retrieved business performance metric(s) may include, but is/are not limited to: business attainment, or the measure of the business's performance (e.g., actual revenue) as a percentage of the business's operating plan (e.g., anticipated revenue) for the given business fiscal period; quota attainment, or the measure of a seller's or seller group's performance (e.g., actual sales) as a percentage of the seller's or seller group's quota (e.g., target sales) for the given business fiscal period; business-to-quota attainment gap, or the difference in basis points (bps) between the business's performance and the seller's (or seller group's) performance for the given business fiscal period. Collectively, the retrieved business performance metric(s) from the identified business metrics database entries are hereinafter referred to filtered business metrics.

In Step 226, a forecast report is generated. In one or many embodiment(s) described herein, the forecast report may include or specify: the sales compensation payout forecast (computed either in Step 212 or Step 222); the filtered business metrics (obtained in Step 224); distribution statistics (e.g., mean, median, standard deviation, etc.) descriptive of the best-fit distribution (identified in Step 206) and/or the rectified best-fit distribution (produced in Step 220); a fraction of sellers value representing the number of anomalous seller(s) (if any) to the total number of sellers in the seller group; and a fraction of payout value representing the portion of the sales compensation payout forecast contributed by the anomalous seller(s) (if any). Information disclosed in the forecast report is not limited to the aforementioned specific examples.

In Step 228, the forecast report (generated in Step 226) is transmitted to the client device that had submitted the forecast request (received in Step 200). Thereafter, in one or many embodiment(s) described herein, any operator(s) of the client device may, at least in part, reference the forecast report to recommend, establish, or adjust a sales compensation payout budget to match the sales compensation payout forecast. The forecast report may also be referenced to make other sales pertinent decisions, such as the recommendation or adjustment of seller group and/or individual seller sales targets/quotas.

FIG. 3 shows a computing system in accordance with one or more embodiments described herein. The computing system (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (6312) (e.g., Bluetooth interface, infrared interface, network interface, optical interface, etc.), input devices (310), output devices (308), and numerous other elements (not shown) and functionalities. Each of these components is described below.

In one or many embodiment(s) described herein, the computer processor(s) (302) may be an integrated circuit for processing instructions. For example, the computer processor(s) may be one or more cores or micro-cores of a central processing unit (CPU) and/or a graphics processing unit (GPU). The computing system (300) may also include one or more input devices (310), such as a touchscreen, keyboard, mouse, microphone, touchpad, electronic pen, or any other type of input device. Further, the communication interface (312) may include an integrated circuit for connecting the computing system (300) to a network (not shown) (e.g., a local area network (LAN), a wide area network (WAN) such as the Internet, mobile network, or any other type of network) and/or to another device, such as another computing device.

In one or many embodiment(s) described herein, the computing system (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or many embodiment(s) described herein.

FIG. 4 shows an example seller group quota histogram in accordance with one or more embodiments described herein. The example seller group quota histogram (400) is presented for explanatory purposes only and not intended to limit the embodiments described herein.

In one or many embodiment(s) described herein, the example seller group quota histogram (400) may refer to a graphical representation (e.g., a bar graph) of the total daily quota attainment distribution reflected in seller group quota data respective to a particular seller group. The graphical representation includes a horizontal axis reflecting two variables: (a) an outer variable referencing any number of time period segments (e.g., as shown, seven days of a week); and (b) an inner variable referencing any equal number of bins or buckets (402) (e.g., as shown, four bins) per time period segment. Each bin/bucket (402), within a set of bins/buckets (402) for a given time period segment, captures a non-overlapping range interval (e.g., 0% to 9%, 10% to 19%, . . . , 130% to 139%, 140% to 149%) in a series of range intervals within a range (e.g., 0% to 149%) of the total daily quota attainment values reflected in the seller group quota data. The graphical representation further includes a vertical axis reflecting a single variable-a frequency of sellers, amongst the particular seller group, that have achieved certain daily quota attainments. For any given bin/bucket (402) within a given time period segment (e.g., Day X), the vertical bar presented there-above in the example seller group quota histogram (400) reflects the number of sellers that, during the given time period segment, has achieved a daily quota attainment within the range interval associated with the given bin/bucket (402).

While embodiments described herein have been described with respect to a limited number of embodiments, those skilled in the art, having benefit of this disclosure, will appreciate that other embodiments can be devised which do not depart from the scope of the embodiments described herein. Accordingly, the scope of the embodiments described herein should be limited only by the attached claims.

1. A method for forecasting sales compensation payouts, the method comprising:
receiving a forecast request from a physical computing device using a network card;
filtering, based on the forecast request, a physical storage device that is implemented using magnetic random-access memory and phase change memory to obtain current seller group quota data;
constructing a current seller group quota histogram using the current seller group quota data and a computer processor that processes computer readable instructions,
wherein the physical computing device and the computer processor are operatively connected to each other over a wide area network that is implemented using a combination of wired and wireless connections;
identifying a best-fit distribution for the current seller group quota histogram; and
computing a sales compensation payout forecast based on the best-fit distribution and an accelerator payout curve.

2. The method of claim 1, wherein the best-fit distribution is identified using reinforcement learning.

3. The method of claim 2, wherein the reinforcement learning comprises a stochastic multi-armed bandit algorithm.

4. The method of claim 1, wherein the current seller group quota data comprises a collection of daily quota attainment values for each seller in a seller group.

5. The method of claim 4, wherein the seller group is identified using a seller group mapping key.

6. The method of claim 5, wherein the seller group mapping key represents a search string comprising a time period, a seller location, and at least one seller line.

7. The method of claim 4, wherein the accelerator payout curve reflects a compensation payout rate for each seller in the seller group.

8. The method of claim 4, the method further comprising:
prior to computing the sales compensation payout forecast:
identifying at least one anomalous seller in the seller group; and
treating the at least one anomalous seller amongst the best-fit distribution to produce a rectified best-fit distribution,
wherein the sales compensation payout forecast is computed using the rectified best-fit distribution in place of the best-fit distribution.

9. The method of claim 8, wherein identification of the at least one anomalous seller comprises applying a median absolute standard deviation technique to the best-fit distribution.

10. A non-transitory computer readable medium (CRM) comprising computer readable program code, which when executed by a computer processor, enables the computer processor to perform a method for forecasting sales compensation payouts, the method comprising:
receiving a forecast request from a physical computing device using a network card;
filtering, based on the forecast request, a physical storage device that is implemented using magnetic random-access memory and phase change memory to obtain current seller group quota data;
constructing a current seller group quota histogram using the current seller group quota data and a computer processor that processes computer readable instructions,
wherein the physical computing device and the computer processor are operatively connected to each other over a wide area network that is implemented using a combination of wired and wireless connections;
identifying a best-fit distribution for the current seller group quota histogram; and
computing a sales compensation payout forecast based on the best-fit distribution and an accelerator payout curve.

11. The non-transitory CRM of claim 10, wherein the best-fit distribution is identified using reinforcement learning.

12. The non-transitory CRM of claim 11, wherein the reinforcement learning comprises a stochastic multi-armed bandit algorithm.

13. The non-transitory CRM of claim 10, wherein the current seller group quota data comprises a collection of daily quota attainment values for each seller in a seller group.

14. The non-transitory CRM of claim 13, wherein the seller group is identified using a seller group mapping key.

15. The non-transitory CRM of claim 14, wherein the seller group mapping key represents a search string comprising a time period, a seller location, and at least one seller line.

16. The non-transitory CRM of claim 13, wherein the accelerator payout curve reflects a compensation payout rate for each seller in the seller group.

17. The non-transitory CRM of claim 13, the method further comprising:
prior to computing the sales compensation payout forecast:
identifying at least one anomalous seller in the seller group; and
treating the at least one anomalous seller amongst the best-fit distribution to produce a rectified best-fit distribution,
wherein the sales compensation payout forecast is computed using the rectified best-fit distribution in place of the best-fit distribution.

18. The non-transitory CRM of claim 17, wherein identification of the at least one anomalous seller comprises applying a median absolute standard deviation technique to the best-fit distribution.

19. A system, the system comprising:
a sales compensation payout forecaster, comprising:
a storage; and
a computer processor operatively connected to the storage, and configured to perform
a method for forecasting sales compensation payouts, the method comprising:
receiving a forecast request from a physical computing device using a network card;
filtering, based on the forecast request, a physical storage device that is implemented using magnetic random-access memory and phase change memory to obtain current seller group quota data;
constructing a current seller group quota histogram using the current seller group quota data retrieved from the storage and a computer processor that processes computer readable instructions,
wherein the physical computing device and the computer processor are operatively connected to each other over a wide area network that is implemented using a combination of wired and wireless connections;
identifying a best-fit distribution for the current seller group quota histogram; and
computing a sales compensation payout forecast based on the best-fit distribution and an accelerator payout curve.

20. The system of claim 19, wherein the best-fit distribution is identified using a stochastic multi-armed bandit algorithm.
